(19) United States
(12) Patent Application Publication
(10) Pub. No.: US 2025/0153998 A1
(43) Pub. Date: May 15, 2025

(54) SEAT ASSEMBLY, CUSHION, AND TOOL AND METHOD OF FORMING

(71) Applicant: Lear Corporation, Southfield, MI (US)

(72) Inventors: Curtis HUDSON, Macomb, MI (US); Eric REPKE, Milford, MI (US); Lisa SWIKOSKI, West Bloomfield, MI (US)

(21) Appl. No.: 19/019,873

(22) Filed: Jan. 14, 2025

Related U.S. Application Data
(62) Division of application No. 18/178,818, filed on Mar. 6, 2023.

(51) Int. Cl. B68G 15/00; B29C 33/04; B68G 7/02

(52) U.S. Cl. CPC B68G 15/00; B68G 7/02; B29C 33/04; B29C 33/046; B29C 33/048

(57) ABSTRACT

A method is provided with a stranded mesh material blank inserted into a cavity of a tool assembly shaped to form a cushion member. Fluid is circulated above a first temperature threshold through a series of apertures defined in a forming surface of the tool assembly and into the cavity thereby softening the blank and conforming a shape of the blank to the forming surface. Fluid is circulated below a second temperature threshold through the series of apertures in the forming surface and into the cavity thereby setting the shape of the blank to the forming surface and forming a cushion member. A cushion for a seat assembly is provided by a stranded mesh material member. A system is provided with a first tool, a second tool, and one or more inlet manifolds.

### CROSS-REFERENCE TO RELATED APPLICATIONS

This application is a division of U.S. application Ser. No. 18/178,818 filed Mar. 6, 2023, the disclosure of which is hereby incorporated in its entirety by reference herein.

### TECHNICAL FIELD

Various embodiments relate to a tool and a method of forming a nonfoam cushion and associated seat assembly, and a nonfoam cushion and a seat assembly.

### BRIEF DESCRIPTION OF THE DRAWINGS

FIG. 1 illustrates a perspective view of a seat assembly according to an embodiment;

FIG. 2 illustrates a partial view a cushion member according to an embodiment and for use with the seat assembly of FIG. 1;

FIG. 3 illustrates a schematic view of a system according to an embodiment;

FIG. 4 illustrates a perspective view of a first tool for use with the system of FIG. 3;

FIG. 5 illustrate a perspective view of a second tool for use with the system of FIG. 3;

FIG. 6 illustrates another perspective view of the first or second tool of FIGS. 4-5;

FIG. 7 illustrates a top schematic view of a system according to another embodiment in a closed position; and

FIG. 8 illustrates a side schematic view of the system of FIG. 7 in an open position.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The terminology controller may be provided as one or more controllers or control modules for the various components and systems. The controller and control system may include any number of controllers, and may be integrated into a single controller, or have various modules. Some or all of the controllers may be connected by a controller area network (CAN) or other system. It is recognized that any controller, circuit, or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

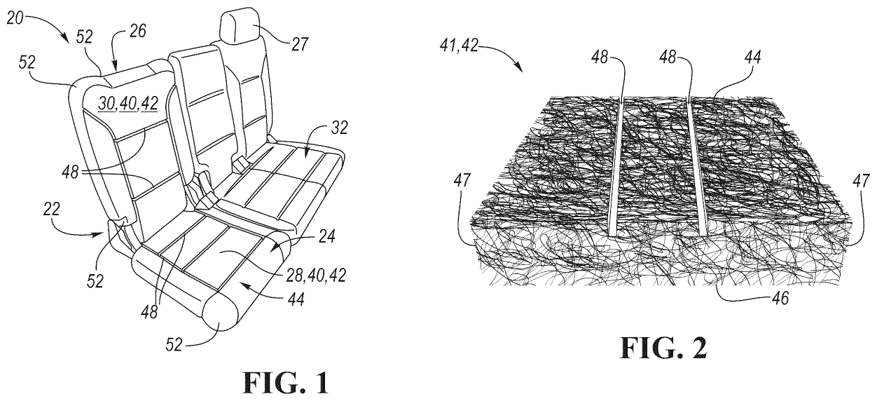

Referring to FIG. 1, a seat assembly 20, such as a vehicle seat assembly 20 is illustrated. In other examples, the seat assembly 20 may be shaped and sized as a front row driver or passenger seat, a second, third, or other rear row seat, and may include bench-style seats as shown, bucket seats, or other seat styles. Furthermore, the seat assembly may be a non-stowable seat or a stowable seat that may be foldable and stowable in a cavity in the vehicle floor. Additionally, the seat assembly 20 may be configured for use with other non-vehicle applications.

The seat assembly 20 has a frame 22 or other support structure. The seat assembly has seat components, and these seat components include at least a seat bottom 24 and a seat back 26. The seat bottom 24 may be sized to receive a seated occupant to support a pelvis and thighs of the occupant. The seat back 26 may be sized to extend upright from the seat bottom 24 to support a back of the occupant. The seat assembly may additionally have a head restraint 27, with the head restraint 27 illustrated for an adjacent seat assembly only. The seat bottom 24 has a seat bottom cushion 28. The seat back 26 has a seat back cushion 30. The frame 22 may include wire suspension mats or other structure to support the cushions 28, 30.

The frame 22 provides rigid structural support for the seat components, e.g. the seat bottom 24 and seat back 26, and may be provided as multiple frame members that are moveable relative to one another to provide adjustments for the seat assembly. The frame may be formed from a stamped steel alloy, a fiber reinforced polymer, or any suitable structural material. The frame 22 may further include a substrate, e.g. a panel, to support the associated cushion.

One or more trim covers 32 are used to cover the seat bottom cushion 28 and the seat back cushion 30, and provide a seating surface for the seat assembly 20. The vehicle seat assembly 20 is shown without a trim cover, and the adjacent seat assembly illustrates the trim cover 32. In one example, the trim cover 32 covers both of the cushions 28, 30. In other examples, multiple trim covers are provided to cover the seat bottom cushion and the seat back cushion. The trim cover 32 may be formed from one or more panels of a fabric, leather, leatherette, vinyl, or other material.

A seating cushion 40 is described in further detail below, and the description may similarly be applied to the seat bottom cushion 28 or the seat back cushion 30. The seating cushion 40 as described herein may additionally be used for other seating components, or for other vehicle interior components.

In the example shown, the seating cushion 40 includes at least one nonfoam component or member 42. In one example, and as shown, the seating cushion 40 is formed solely from the nonfoam component 42, such that the nonfoam component 42 provides all of the cushioning for the seat component between the frame 22 and the trim cover 32. In other examples, the seating cushion 40 may be formed from a nonfoam component 42 as well as one or more foam components, such as a component formed from molded polyurethane foam, or other nonfoam components. The seating cushion 40 may have the nonfoam and foam components positioned to provide different regions of the cushion 40 for the seating component, e.g. a central region, and side bolster regions. By removing some or all of the traditional foam from the seating cushion 40, the seat assembly 20 may be provided with improved support and comfort, and reduced weight.

In one non-limiting example, the nonfoam component or member 42 of the seating cushion 40 is formed by a stranded mesh material, also known as an entangled three-dimensional filament structure. The stranded-mesh material is made from a polymeric mesh having a plurality of integrated polymeric strands. The stranded-mesh material may be made from, for example, a linear low density polyethylene (LLPDE) material, although other polymers and materials effective to provide the desired properties and functionality are contemplated. The stranded-mesh material may be formed using extruded filaments of linear low-density polyethylene (LLDPE) that are randomly entangled, bent, looped, or otherwise positioned and oriented, and directly bonded to each other to provide a porous mesh structure, an example of which is shown in a closer view in FIG. 2.

Referring to FIG. 2, the cushion may be formed from a cushion blank 41, or stranded mesh material blank 41, of a stranded-mesh material member 42 that includes a first surface 44 and a second surface 46 positioned opposite to the first surface 44. Side surfaces 47, or edges, extend between the first and second surfaces 44, 46. The first surface 44 may be positioned on the seat assembly 20 to support an occupant of the seat assembly. The various surfaces 44, 46, 47 may be formed from a cushion blank via a system as described below, and may include various features such as recesses, trenches, channels, concave or convex surfaces, or other contours on the surfaces 44, 46, 47, or at the intersection of associated surfaces 44, 46, 47. The cushion blank 41 may include one or more slits 48, or cuts into the cushion blank 41 that are used with the system as described below to form various features or shapes in the cushion 40 from the blank 41.

The cushion blank 41 may be formed from a consolidated filament structure that provides the stranded mesh material from which the cushion 40 and member 42 as described above is formed. Material stock such as solid granules or pellets of a plastic, such as a linear low-density polyethylene (LLDPE) may be fed from a hopper to an extruder. The extruder melts the material stock and transports it through a die plate. The material exits the extruder under pressure and in a molten state. The die plate extrudes the material into filaments via multiple small circular through holes or apertures through which the molten material passes such that a single filament is extruded from each die plate hole. The filaments fall from the die plate to a funnel to help consolidate or group the filaments into a more compact arrangement in which the filaments bend or loop and each filament contacts and bonds to at least one other filament. The consolidated filament structure then enters a fluid bath, such as a liquid tank to help temporarily support the consolidated filament structure, maintain the porosity and density, and cools the filaments from the outside to solidify them. The tank may be provided with various rollers and conveyors, and the consolidated filament structure may be cut to a desired sized and shape to form a cushion blank, e.g. using a cutting wheel, a water jet, or another technique. In one non-limiting example, the cushion blank 41 is provided as a generally rectangular prism.

The cushion blank 41 may be further cut prior to use with the system as described below in order to form one or more slots or slits 48. The cushion blank 41 may be cut to a blind depth, or partially through the blank 41, to form a slot 48. The cushion blank 41 may be further cut to a near-net shape based on the desired shape and size of the cushion 40, as well as the desired localized density properties of the cushion 40.

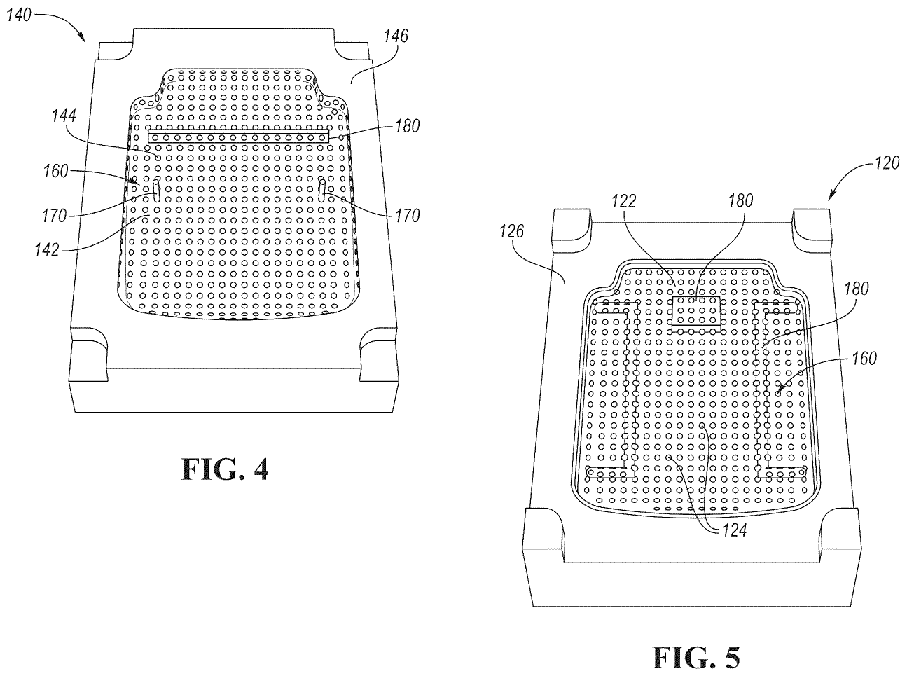

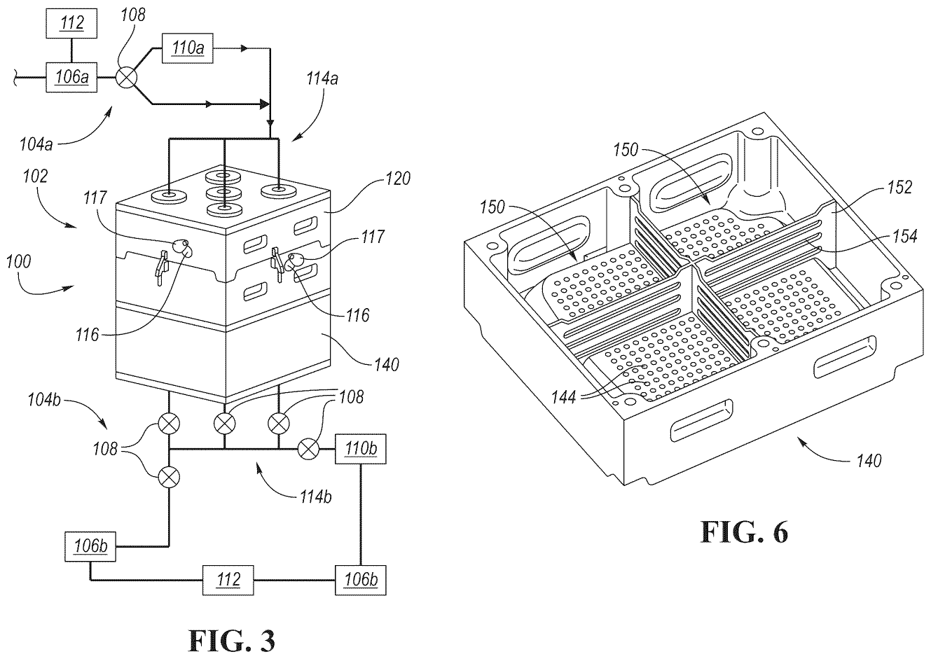

FIG. 3 illustrates a system 100 for shaping the cushion 40 from a cushion blank 41. A cushion blank 41 is positioned within the system 100 to shape the cushion blank 41 into the desired final shape and with the features, e.g. recesses, contours, etc., for the cushion 40. The cushion blank 41 is formed from a consolidated filament structure as described above after the material has been cooled and cut into blank form.

The system 100 has a tool assembly 102. The tool assembly 102 is in fluid communication with one or more fluid systems 104. Each fluid system 104 has a fluid transfer device 106 such as a pump or fan, one or more valves 108, and a heater 110. The fluid system 104 may provide a flow of pressurized gas, such as air, or a liquid to the tool assembly 102, with the flow controller via a controller 112. In the non-limiting example shown, the fluid system(s) 104 provide air to the tool assembly 102.

Referring to FIGS. 3-6, the tool assembly 102 of the system 100 has a first tool 120 and a second tool 140. The first tool 120 has a first forming surface 122 defining a series of first apertures 124 therethrough. The second tool 140 has a second forming surface 142. In one non-limiting example, the second forming surface 142 defines a series of second apertures 144 therethrough. The first and second forming surfaces 122, 142 cooperate to define a cavity 160 and shaped to form a cushion member from the blank 41. The cavity 160 is shaped to form various shapes into the cushion 40 from the blank 41, including concave, convex, or other complex shapes; channels, recesses, curves, chamfers, stepped corners or regions, or the like. The cavity 160 may further be sized to be smaller in volume than the blank 41, such that the tool assembly 102 compresses the blank 41 in the tool assembly, which may provide different localized densities in different regions in the cushion 40. In other words, the blank 41 may be oversized relative to the cavity 160. The variation in localized densities in the resulting cushion 40 may be advantageous, e.g. by providing an increased density in a thinner section or region.

Collectively, the first and second tools 120, 140 each define a portion of the apertures 124, 144 in the tool assembly forming surfaces 122, 142. The apertures 124, 144 in each of the first and second tools are illustrated as being circular; however, the apertures may be provided with other cross-sectional shapes. The apertures 124, 144 may be provided with a common diameter, or may be provided with varying diameters, e.g. to better control the flow to various regions of the cushion blank 41 in the tool assembly 102. The apertures 124, 144 may additionally be generally equally spaced from one another on the forming surfaces, or the spacing between the apertures may vary, likewise providing control over the flow to various regions of the cushion blank 41 in the tool assembly 102. In various examples, there may be certain regions of the forming surfaces 122, 142 that are provided without apertures.

The first tool 120 has a mating surface 126 that cooperates with a corresponding mating surface 146 of the second tool 140 when the tool assembly 102 is closed. The first tool 120 may be translated or otherwise moved towards and away from the second tool 140 to open and close the tool assembly.

In the example shown, the tool assembly 102 has a first fluid system 104a and a second fluid system 104b. Although the first and second fluid systems 104a, 104b are illustrated and described differently with respect to one another, in other examples, two fluid systems 104a, two fluid systems 104b, or a single fluid system 104a, 104b may be used.

The first fluid system 104a has a fluid transfer device 106a selectively connected to a heater 110a via a valve 108. The controller 112 controls the position of the valve 108 and the operation of the heater 110a to provide fluid to the first inlet manifold 114a and the first tool 120 as described below. The first inlet manifold 114a may further have valves 108 to selectively control flow through each of the manifold 114a lines, e.g. by controlling the flow rate. The inlet manifold 114a is fluidly connected to the first tool 120 and to the cavity 160 via the series of first apertures 124. The fluid system 104a is fluidly connected to the tool assembly 102 via the inlet manifold 114a. The inlet manifold 114a may provide more than one inlet port into the first tool 120 as shown, or may provide a single inlet.

The second fluid system 104b has two fluid transfer devices 106b. One fluid device 106b is connected to a heater 110b, with the heater 110b connected to the inlet manifold 114b via a valve 108. The other fluid transfer device 106b is connected to the inlet manifold 114b by another valve 108. The controller 112 controls the position of the valves 108, fluid transfer devices 106b, and the heater 110b to provide fluid to the first inlet manifold 114b and the second tool 140 as described below. The first inlet manifold 114a may further have valves 108 to selectively control flow through each of the manifold 114a lines, e.g. by controlling the flow rate. The inlet manifold 114a is fluidly connected to the first tool 120 and to the cavity 160 via the series of first apertures 124. The fluid system 104a is fluidly connected to the tool assembly 102 via the inlet manifold 114a. The inlet manifold 114a may provide more than one inlet port into the first tool 120 as shown, or may provide a single inlet.

In further examples, various features of the fluid systems 104a, 104b may be combined, for example, with a single controller 112, or by using one fluid transfer device and/or heater to provide fluid flow to both manifolds 114a, 114, or the like.

The interior of the first tool 120 and the second tool 140 may each form one or more chambers opposite to the forming surfaces 122, 142, with the associated apertures 124, 144 connecting the forming surface to the respective chamber(s). FIG. 6 illustrates a view of the second tool 140 opposite to the forming surface 142, with the tool 140 having four chambers 150 divided by internal support walls 152. The internal support walls 152 provide structural support for the forming surface 142, and also may separate flow streams to maintain or control the uniformity of the flow. In other examples, apertures 154 may be provided in the support walls 152 as shown to provide cross-flow between the chambers 150.

The first tool 120 may be configured similarly to the second tool 140, with one or more support walls 152 forming multiple chambers 150 in the first tool. The inlet manifold 114, such as manifold 114a, 114b, may provide one or more inlet ports associated with each chamber 150 in the first tool and/or second tool 140. As such, the flow to different chambers 150 in the first tool and/or second tool 140, and different regions of the cavity 160 and blank 41 may be likewise controlled.

In addition to the support walls 152, the chambers 150 in the first and second tools may support various flow diverters, baffles, and other features to control the flow direction into or from the cavity 160 and through the blank 41.

In the example shown, the tool assembly 102 is provided with one or more outlets 116 that are formed in the first tool 120, the second tool 140, or in both tools 120, 140. The outlets 116 fluidly connect and vent the cavity 160 to atmosphere either directly via the cavity 160 or via one of the chambers 150, and when air is the fluid in the systems 104, or may be connected to a return line to the fluid system(s) 104a, 104b for closed systems. The outlets 116 may be provided with a closure member 117, such as a baffle, plate, or valve. The closure member 117 may be further controlled, e.g. via the controller 112 between an open position to vent the cavity, or a closed position to retain or maintain fluid within the cavity 160. In various examples, the closure members 117 may be closed or opened while the fluid transfer devices 106 and/or heaters 110 are being operated, e.g. to provide the desired temperature profile within the cavity 160. In other examples, the tool assembly 102 is provided without closure members 117 such that the outlets(s) 116 are not closable. In a further example, the tool assembly 102 is provided without defined outlet ports 116, and the tool assembly 102 may vent via various gaps or spaces between the mating surfaces 126, 146. The fluid flows from each fluid system 104a, 104b, into their respective inlet manifolds 114a, 114b, into the cavity 160, and then to the outlet(s) 116.

In a further example, the tool assembly 102 is provided with a single fluid system 114a or 114b, and a single outlet 116 in place of the other inlet manifold 114b, 114a, such that fluid flows sequentially from one inlet manifold, through both tools 120, 140, and to an outlet 116 sequentially. The fluid may flow sequentially in the assembly 102 from the inlet manifold 114, into the chambers 150 in the first tool 120, through the first series of apertures 124, through the cavity 160 and blank 41, through the series of second apertures 144, into the chambers 150 in the second tool 140, and to the outlet 116. As described below, the fluid may be at various temperatures to control the shaping of the blank 41.

As the blank 41 is formed from a stranded mesh material and is porous, the fluid flow into the inlet manifold 114, flows through the series of first apertures 124 in the first tool, through the stranded mesh material of the blank 41, through the series of second apertures 144 in the second tool, and to the outlet 116. The fluid therefore convectively heats or cools the filaments and strands internally in the blank 41, as well as the strands along the outer surfaces of the blank 41.

The first tool 120 and/or the second tool 140 may be provided with or more locating members 170 extending outwardly from the respective forming surface 122, 142. In the example shown, the second tool 140 has a plurality of locating members 170 provided as pins. The locating features 170 may be used to position the blank and retain the blank 41 in the desired position on the tool before and while the tool assembly is closed. As the blank 41 is a filament structure, the pins 170 easily extend into the blank 41 and between the filaments when locating the blank on the tool. In further examples, the locator pins 170 may optionally be retractable such that they are retracted when the tool assembly is opened to facilitate removal of the cushion 40.

The forming surface 122 and/or the forming surface 142 may be provided with one or more protrusions 180 to form a corresponding channel, recess, pocket, or other concave region in the cushion 40 from the blank 41. Depending on the geometry of the protrusion 180, the blank 41 may be cut in a location corresponding to the protrusion prior to inserting the blank into the tool assembly. For example, when a channel is being formed, the blank 41 may be cut with a blind cut or slit 48 to provide relief and reduce gaps, warp, or distortion adjacent to the channel in the resulting cushion 40. Likewise, when a recessed region is being formed, blank 41 may be cut with a blind cut or slit 48 along the outer perimeter of the recess to provide relief and reduce gaps or warp adjacent to the recess in the resulting cushion 40 as the protruding forming surface 180 presses the blank material in the recessed region. In other examples, other types of cuts may be provided such as a planar cut, a curved cut, or another complex geometry cut as a part of a through cut or a partial cut into the blank 41. These protrusions 180 may further provide locating features or members for the tool assembly 102.

The system 100 also has a controller 112. The controller 112 is configured to control the fluid transfer device(s) 106, the valves 108, and the heater(s) 110 to selectively fluidly couple the heater 110 to the inlet manifold 114 to provide fluid to the cavity 160 at a first temperature, and selectively fluidly decouple the inlet manifold 114 from the heater 110 to provide fluid to the cavity 160 at a second temperature less than the first temperature. To the extent that the tool assembly 102 has closure members 117 for the outlets, the controller 112 may control the position of the closure members 117 to retain fluid within the cavity 160 or vent the cavity. For example, the controller 112 may close the closure members 117 when providing fluid at the first temperature, and open the closure members 117 when providing fluid at the second temperature, or vice versa. The controller 112 may further at least partially open or at least partially close the closure members 117 while providing fluid at the first temperature and/or second temperature to control the temperature profile within the cavity 160. The system 100 may have various sensors, such as temperature sensors, for use in controlling the flow through the tool assembly 102. The first and second temperatures may be set based on a softening temperature of the material for the filaments of the blank 41. In one example, the first temperature is set at an offset above the softening temperature, e.g. twenty to thirty degrees Celsius above the softening temperature. In another example, the second temperature is set at an offset below the softening temperature, and may be provided at ambient temperature. The controller 112 may further control the time that the fluid is provided into the cavity 160 at the first temperature, the time that the fluid is provided to the cavity 160 at the second temperature, the flow rate of the fluid, and/or the ramp on the temperature of the fluid in order to further control the shaping process for the blank 41. The controller 112 may additionally control valves 108 on individual lines in the inlet manifold 114 to control flow to various chambers 150 in the tools 120, 140, and to different regions of the cavity 160.

The softening temperature may refer to the glass transition temperature of the material, and be less than the melting point, thereby allowing the filaments to soften and change shape of the filament and the blank 41, without completely melting the filaments and losing the overall filament structure and porosity in the blank 41 and resulting cushion.

In various examples, a method is provided for use with the system 100 and controller 112 and to form a cushion 40 from a cushion blank 41 or a stranded mesh material blank 41. In a first step, the blank is inserted into a cavity 160 of a tool assembly 102 shaped to form a cushion member. The first tool 120 is moved relative to the second tool 140 of the tool assembly after the blank is inserted into the cavity to close the tool assembly with the blank inside. The blank 41 may be compressed by the first and second tools 120, 140 as the size of the blank 41 may be larger than the cavity 160, e.g. the volume of the blank may be greater than the volume of the cavity. In various examples, the blank 41 may be compressed to different degrees in different regions based on the size and shape of the blank 41 relative to the size and shape of the cavity 160.

To the extent that there are any slot(s) 48 cut into the blank 41, a corresponding protrusion 180 of the forming surface is inserted into the slot of the blank when inserting the blank into the cavity 160 of the tool assembly.

Note that the tools 120, 140 may be preheated prior to insertion of the blank 41 into the tool assembly, or any heating to the tools 120, 140 may occur only after the blank 41 is inserted via the fluid flow at the first temperature.

In a second step, the controller 112 operates the fluid transfer device(s) 106, the valves 108, and the heater(s) 110 to circulate fluid above a first temperature threshold into the inlet manifold 114 and through a series of apertures 124 defined in a forming surface 122 of the tool assembly and into the cavity 160 thereby softening the blank 41 and conforming a shape of the blank to the forming surfaces 122, 142. The controller 112 may further control any closure members 117, e.g. to a closed position to generally retain fluid within the cavity 160, and/or to an open position to vent the cavity 160.

In a third step, the controller 112 then controls the fluid transfer device 106, the valves 108, and the heater 110 to circulate the fluid below a second temperature threshold through the series of apertures 124 in the forming surfaces 122 and into the cavity 160 thereby setting the shape of the blank 41 to the forming surfaces 122, 142 and forming a cushion member. In various examples, the first temperature threshold is greater than a softening temperature of the blank 41, and the second temperature threshold is less than a softening temperature of the blank 41. In a further example, the fluid may be provided to the tool assembly at an ambient temperature during the third step. The controller 112 may further control any closure members 117, e.g. to an open position to generally vent fluid within the cavity 160, and/or to a closed position.

The second step may be a first temperature cycle for the blank 41 to soften and shape the blank 41 to the shape defined by the forming surfaces, and the third step may be a second temperature cycle for the blank to set the shape of the blank 41. In various examples, the first, second, and third steps may be performed sequentially.

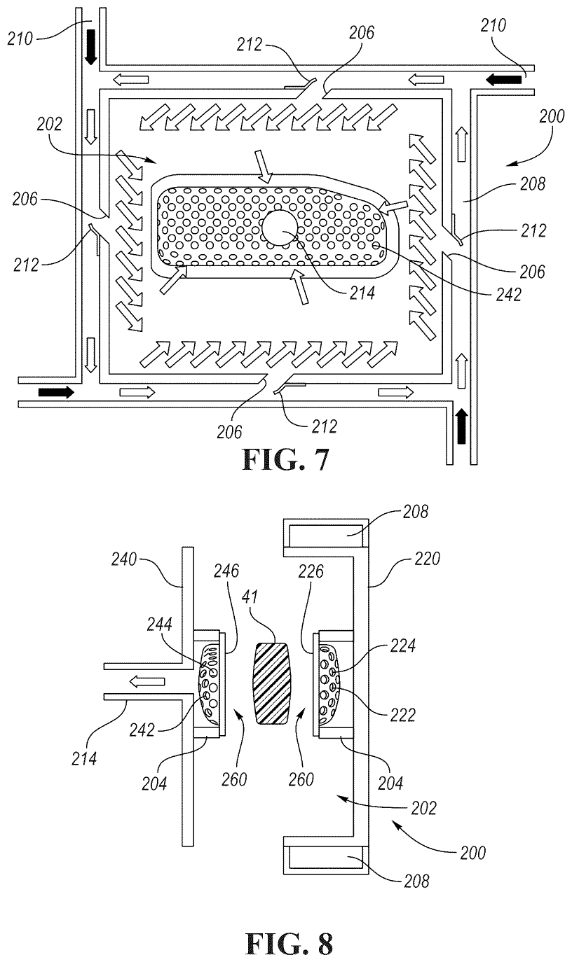

Referring to FIGS. 7-8, a tool assembly 200 is illustrated schematically according to another embodiment. In various examples, the tool assembly 200 may be used in place of the tool assembly 102 and with the system 100 of FIG. 3 and generally according to the method, as described above. Elements that are the same as or similar to those described above may not be described with respect to FIGS. 7-8 for simplicity. FIG. 7 illustrates a top schematic view of the tool assembly 200, and FIG. 8 illustrates a side schematic view of the tool assembly 200 in an open position.

The tool assembly 200 has a first tool 220 and a second tool 240. The first tool 220 and the second tool 240 are each positioned within a central region of a common chamber 202. Each of the first and second tools 220, 240 may be supported by standoffs or other support members 204 within the chamber 202. The first tool 220 has a first forming surface 222 defining a series of first apertures 224 therethrough. The second tool 240 has a second forming surface 242 defining a series of second apertures 244 therethrough. The first and second forming surfaces 222, 242 cooperate to define a cavity 260 shaped to form a cushion from a cushion blank 41. The first tool 220 has a mating surface 226 that mates with a corresponding mating surface 246 of the second tool when the tool assembly 200 is closed. The first tool 220 may be translated or otherwise moved towards and away from the second tool 240 to open and close the tool assembly.

The chamber 202 has at least one inlet 206 in fluid communication with the circumferential inlet manifold 208 in fluid communication with a fluid system, such as fluid system 104a or 104b. The inlet manifold 208 extends about an outer peripheral of the chamber 202, or along at least a portion of the outer perimeter of the chamber. The inlet(s) 206 from the inlet manifold 208 to the chamber 202 is provided along the outer perimeter wall of the chamber. The circumferential inlet manifold 208 may receive fluid from the inlet manifold 114 via ports 210, or may be a part of the inlet manifold. In the example shown, the chamber has a single inlet 206; however, other numbers of inlets 206 are also contemplated. The circumferential inlet manifold 208 may receive flow from a single port 210 or from multiple ports 210 as shown. The inlet 206 may have an associated deflector 212. The deflector may extend into the circumferential inlet manifold 208 at an angle in order to help direct from the manifold 208 with the desired flow angle. The inlet 206 may further be formed with walls that are angled relative to the adjacent circumferential flow manifold 208 and with respect to the direction of fluid flow therein, as shown in FIG. 7. In one non-limiting example the deflector 212 and the angle of the inlet 206 are at forty-five degrees, although other acute angles are also contemplated. Although only one inlet 206 is shown, multiple inlets 206 and deflectors are contemplated, with the inlets 206 spaced along the circumferential manifold 208 to assist in created a vortex flow or circular flow within the chamber 202.

The chamber 202 also defines an outlet 214. The outlet 214 is positioned to fluidly connect the central region of the chamber 202 to atmosphere such that fluid circulates radially inward within the chamber 202 from the inlet(s) 206 along the outer perimeter of the chamber 202 (and from the circumferential inlet manifold 208) to the outlet 214. This generally provides a vortex flow geometry within the chamber 202.

The tool assembly 200 may be positioned in the system 100 and controlled via controller 112 according to a method as described above. According to various examples, the fluid flows sequentially in the assembly 102 from the inlet manifold 114, circumferential manifold 208, through the inlets 206 and into the chamber 202, and then has a vortex or circular flow path towards the tools 220, 240. The fluid flows through the apertures 224, 244 in the tools 220, 240 and through the cavity 160 and blank 41, and to the outlet 214. As described above, the fluid may be at various temperatures to control the shaping of the blank 41.

As the blank 41 is formed from a stranded mesh material and is porous, the fluid flow into the inlet manifold 114, flows through the series of first apertures 124 in the first tool, through the stranded mesh material of the blank 41, through the series of second apertures 144 in the second tool, and to the outlet 116. The fluid therefore convectively heats or cools the filaments and strands internally in the blank 41, as well as the strands along the outer surfaces of the blank 41.

Clause 1. A method is provided and a stranded mesh material blank is inserted into a cavity of a tool assembly shaped to form a cushion member. Fluid is circulated above a first temperature threshold through a series of apertures defined in a forming surface of the tool assembly and into the cavity thereby softening the blank and conforming a shape of the blank to the forming surface. Fluid is circulated below a second temperature threshold through the series of apertures in the forming surface and into the cavity thereby setting the shape of the blank to the forming surface and forming a cushion member.

Clause 2. The method of clause 1 further comprising moving a first tool of the tool assembly relative to a second tool of the tool assembly after the stranded mesh material blank is inserted into the cavity.

Clause 3. The method of clause 2 wherein the first tool defines a first portion of the series of apertures, and wherein the second tool defines a second portion of the series of apertures.

Clause 4. The method of clause 2 further comprising compressing the stranded mesh material blank by moving the first tool relative to the second tool.

Clause 5. The method of any one of clauses 1-4 further comprising cutting a slot in the stranded mesh material blank to a blind depth prior to inserting the blank into the cavity of the tool assembly, and inserting a protrusion of the forming surface into the slot of the blank when inserting the blank into the cavity of the tool assembly.

Clause 6. The method of any one of clauses 1-5 wherein the first temperature threshold is greater than a softening temperature of the blank, and wherein the second temperature threshold is less than a softening temperature of the blank.

Clause 7. The method of any one of clauses 1-6 further comprising forming the stranded mesh material member blank as a polymeric mesh having a plurality of integrated polymeric strands.

Clause 8. The method of clause 7 further comprising forming the stranded mesh material member by extruding material through a die, funneling the extruded material from the die through a funnel, and moving the extruded material after the funnel via one or more rollers; and cutting the stranded mesh material blank after forming and prior to inserting the blank into the cavity of the tool assembly.

Clause 9. A cushion for a seat assembly, the cushion comprising a stranded mesh material member formed by the method of clause 8.

Clause 10. A system is provided with a first tool comprising a first forming surface defining a series of first apertures therethrough, and a second tool comprising a second forming surface defining a second series of apertures therethrough, with the first and second forming surfaces cooperating to define a cavity and shaped to form a cushion member. An inlet manifold is fluidly connected to the cavity via at least one of the series of first apertures or the series of second apertures.

Clause 11. The system of clause 10 wherein the first tool defines one or more first chambers in fluid communication with the inlet manifold, the one or more first chambers in fluid communication with the cavity via the series of first apertures in the first forming surface.

Claim 12. The system of clause 10 or 11 wherein the inlet manifold is a first inlet manifold supported by the first tool and fluidly connected to the cavity via the series of first apertures, and wherein the system further comprises a second inlet manifold supported by the second tool and fluidly connected to the cavity via the second series of apertures.

Clause 13. The system of any one of clauses 10-12 further comprising an outlet fluidly coupled to the inlet manifold via the series of first apertures and the cavity.

Clause 14. The system of clause 13 wherein the outlet is at least partially defined by one or more outlet ports in at least one of the first tool or the second tool, wherein each of the one or more outlet ports comprise a closure member movable between an open position and a closed position.

Clause 15. The system of clause 13 wherein the first tool and the second tool are positioned within a central region of a chamber, the chamber having at least one inlet in fluid communication with the inlet manifold, and defining the outlet.

Clause 16. The system of clause 15 wherein the inlet manifold extends along at least a portion of an outer perimeter wall of the chamber, the inlet is positioned along the outer perimeter wall of the chamber; and the outlet is positioned to fluidly connect the central region of the chamber to atmosphere such that fluid circulates radially inward within the chamber from the inlet to the outlet.

Clause 17. The system of clause 16 wherein the inlet further comprises a deflector positioned to extend into the inlet manifold and direct fluid into the chamber.

Clause 18. The system of any one of clauses 10-17 further comprising one or more locating members extending outwardly from the first forming surface and/or the second forming surface.

19. The system of any one of clauses 10-18 further comprising a fluid transfer device, a heater, a valve in fluid communication with the inlet manifold, and a controller. The controller is configured to control the valve to selectively fluidly couple the heater to the inlet manifold to provide fluid to the cavity at a first temperature, and selectively fluidly decouple the inlet manifold from the heater to provide fluid to the cavity at a second temperature less than the first temperature.

Clause 20. A system is provided with a first tool comprising a first forming surface defining a series of first apertures therethrough, and a second tool comprising a second forming surface defining a series of second apertures therethrough, with the first and second forming surfaces cooperating to define a cavity and shaped to form a cushion member. One or more inlet manifolds are provided. A fluid system is provided with a fluid transfer device, a valve, and a heater in fluid communication with the inlet manifold. A controller is configured to control the valve to selectively fluidly couple the heater to the inlet manifold to provide fluid to the cavity at a first temperature, and selectively fluidly decouple the inlet manifold from the heater to provide fluid to the cavity at a second temperature less than the first temperature.

Clause 21. Any one of the preceding clauses 1-20 in any combination.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. A method comprising:
inserting a stranded mesh material blank into a cavity of a tool assembly shaped to form a cushion member;
circulating fluid above a first temperature threshold through a series of apertures defined in a forming surface of the tool assembly and into the cavity thereby softening the blank and conforming a shape of the blank to the forming surface; and
circulating fluid below a second temperature threshold through the series of apertures in the forming surface and into the cavity thereby setting the shape of the blank to the forming surface and forming a cushion member.

2. The method of claim 1 further comprising moving a first tool of the tool assembly relative to a second tool of the tool assembly after the stranded mesh material blank is inserted into the cavity.

3. The method of claim 2 wherein the first tool defines a first portion of the series of apertures, and wherein the second tool defines a second portion of the series of apertures.

4. The method of claim 2 further comprising compressing the stranded mesh material blank by moving the first tool relative to the second tool.

5. The method of claim 1 further comprising cutting a slot in the stranded mesh material blank to a blind depth prior to inserting the blank into the cavity of the tool assembly; and inserting a protrusion of the forming surface into the slot of the blank when inserting the blank into the cavity of the tool assembly.

6. The method of claim 1 wherein the first temperature threshold is greater than a softening temperature of the blank, and wherein the second temperature threshold is less than a softening temperature of the blank.

7. The method of claim 1 further comprising forming the stranded mesh material member blank as a polymeric mesh having a plurality of integrated polymeric strands.

8. The method of claim 7 further comprising forming the stranded mesh material member by extruding material through a die, funneling the extruded material from the die through a funnel, and moving the extruded material after the funnel via one or more rollers; and cutting the stranded mesh material blank after forming and prior to inserting the blank into the cavity of the tool assembly.

9. A cushion for a seat assembly, the cushion comprising a stranded mesh material member formed by the method of claim 8.
